(19) United States
(12) Patent Application Publication
(10) Pub. No.: US 2005/0219965 A1
(43) Pub. Date: Oct. 6, 2005

(54) Record medium reproduction unit and method for recognizing record medium of reproduction unit

(75) Inventors: Hideki Kinoshita, Kawagoe (JP); Jun Togashi, Kawagoe (JP); Akira Yasaki, Kawagoe (JP); Shigeru Kojima, Kawagoe (JP); Norio Matsuda, Kawagoe (JP); Hitoshi Yamazaki, Kawagoe (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/094,588

(22) Filed: Mar. 31, 2005

(30) Foreign Application Priority Data
Mar. 31, 2004 (JP) 2004-104743

(51) Int. Cl. G11B 7/085

(52) U.S. Cl. 369/30.27

(57) ABSTRACT

A record medium reproduction unit has a main casing, a transfer device, a pair of sensing pins, a sensing device, and a decision device. The transfer device transfers a larger disk record medium and a smaller disk record medium into and out of the main casing. The sensing pins are movable toward and away from each other and each contact an outer edge of the larger disk record medium when the larger disk record medium enters the main casing. The decision device determines which is inserted into the main casing, the larger disk record medium, the smaller disk record medium, or a special form record medium such as a card-shaped CD based on information supplied from the pair of sensing pins.

### BACKGROUND OF THE INVENTION

1. Field of the Invention

The present invention relates to a record medium reproduction unit mounted, for example, on a motor vehicle, more particularly to a record medium reproduction unit for reproducing information stored in a disk-type record medium such as a compact disk having a 12 cm or 8 cm diameter.

2. Background Art

A recent known record medium reproduction unit receives a record medium like a compact disk (called as CD hereinafter) to read out information supplied from the record medium. Such a reproduction unit is disclosed in Japanese Patent Laid-open No. H-11-176069, 2002-42399, 2003-338112, or 2002-313007. This type reproduction unit may be mounted on a motor vehicle and has a main casing, a transfer device, and a reproduction device.

The main casing is a flat box having an entry opening for inserting and ejecting the record medium. The transfer device moves the record medium through the opining into or from the main casing. The reproduction device reads out information from the record medium received in the main casing.

Thus configured record medium reproduction unit receives, for example, a larger CD record medium having a 12 cm diameter or a smaller CD record medium having a 8 cm diameter to read out information therefrom.

Recently, besides the larger and smaller CD record mediums, there is provided a special form record medium having an outline of a rectangular or barrel card shape. The barrel-shaped card record medium has straight side edges with arc-shaped top and bottom ends.

The conventional record medium reproduction unit disadvantageously receives a special form record medium such as the card type record medium but can not set the special form record medium in the main casing to read out information from the record medium. Furthermore, it is difficult that the record medium is rejected from the main casing.

Therefore, there has been desired a record medium reproduction unit that can distinguish a circular disk record medium from the special form record medium different from the circular one. Such a record medium reproduction unit can desirably eject the special form record medium before complete insertion of it in a main casing of the reproduction unit.

### SUMMARY OF THE INVENTION

An object of the invention is to provide a record medium reproduction unit capable of distinguishing a circular disk record medium from a special form record medium different from the circular one in shape and to provide a record medium recognition method to recognize the special form record medium.

For achieving the object, an aspect of the present invention is a record medium reproduction unit having a main casing for respectively receiving a larger disk record medium and a smaller disk record medium to reproduce information recorded in the record mediums. The reproduction unit includes:
a pair of sensing pins movable toward and away from each other and resiliently biased toward each other, the sensing pins each contacting an outer edge of the larger disk record medium to be moved away from each other when the larger disk record medium enters the main casing, at least one of the sensing pins contacting an outer edge of the smaller disk record medium to be moved away from the other pin when the smaller disk record medium enters the main casing,
a sensing device for detecting a travel distance of each of the sensing pins,
a transfer device for transferring the record mediums into and out of the main casing, and
a decision device for determining which is being inserted into the main casing, the larger disk record medium, the smaller disk record medium, or a special form record medium based on a travel distance of each of the sensing pins. The transfer device ejects the special form record medium from the main casing when the decision device determines that the special form record medium is inserted. The special form record medium is different from the larger and smaller disk record mediums in outline.

A second aspect of the invention is a method for recognizing a record medium for a record medium reproduction unit. The production unit has a main casing for respectively receiving a larger disk record medium and a smaller disk record medium to reproduce information recorded in the record mediums. The reproduction unit also has a pair of sensing pins movable toward and away from each other and resiliently biased toward each other. The sensing pins each contact an outer edge of the larger disk record medium to be moved away from each other when the larger disk record medium enters the main casing. At least one of the sensing pins contacts an outer edge of the smaller disk record medium to be moved from the other pin when the smaller disk record medium enters the main casing. The reproduction unit further has a sensing device for detecting a travel distance of each of the sensing pins. The method comprises the steps of:
determining an outer diameter of a record medium inserted into the main casing based on a maximum distance between the pair of sensing pins, and
determining an outline of the inserted record medium based on a travel rate of each of the sensing pins when the sensing pins each contact an outer edge of the inserted record medium and move toward each other.

### BRIEF DESCRIPTION OF THE DRAWINGS

FIG. 1 is a perspective view showing a profile of a CD player that is a record medium reproduction unit according to an embodiment of the present invention;

FIG. 2 is a plan view showing a larger CD record medium from which the CD player of FIG. 1 reads out information;

FIG. 3 is a plan view showing a smaller CD record medium from which the CD player of FIG. 1 reads out information;

FIG. 4 is a plan view showing a card-shaped CD that is a special form record medium which must be prevented from entering a main casing of the CD player of FIG. 1;

FIG. 5 is a plan view showing a modified example of the card-shaped CD of FIG. 4;

FIG. 6 is an explanatory schematic view showing major constitutions of the CD player of FIG. 1;

FIG. 7 is one part of a flowchart showing steps for recognizing CDs by the CD player of FIG. 6;

FIG. 8 is another part of the flowchart;

FIG. 9 is an explanatory schematic view showing a state where the larger CD is inserted into the CD player of FIG. 6;

FIG. 10 is an explanatory schematic view showing a state where the larger CD is further inserted into the CD player;

FIG. 11 is an explanatory schematic view showing a state where the larger CD is still further inserted into the CD player;

FIG. 12 is an explanatory schematic view showing a state where the smaller CD is inserted into the CD player of FIG. 6;

FIG. 13 is an explanatory schematic view showing a state where the smaller CD of FIG. 12 is further inserted into the CD player;

FIG. 14 is an explanatory schematic view showing a state where the smaller CD of FIG. 13 is still further inserted into the CD player;

FIG. 15 is an explanatory schematic view showing another state where the smaller CD of FIG. 12 is inserted into the CD player;

FIG. 16 is an explanatory schematic view showing a state where the card-shaped CD of FIG. 4 is inserted into the CD player;

FIG. 17 is an explanatory schematic view showing another state where the card-shaped CD is inserted into the CD player;

FIG. 18 is an explanatory schematic view showing further another state where the card-shaped CD is inserted into the CD player;

FIG. 19 is an explanatory schematic view showing further another condition where the card-shaped CD of FIG. 4 is inserted into the CD player; and

FIG. 20 is an explanatory schematic view showing further another state where the card-shaped CD of FIG. 19 is inserted into the CD player.

### DETAILED DESCRIPTION OF THE PREFERRED EMBODIMENTS

A record medium reproduction unit of an embodiment according to the present invention will be discussed hereinafter. The record medium reproduction unit has a pair of sensing pins moving toward and away from each other when the sensing pins is contacting an outer edge of a record medium inserted into a main casing of the reproduction unit. The record medium reproduction unit also has a decision device for determining whether the inserted record medium has a circular shape based on the movements of the sensing pins. Thereby, the decision device can distinguish a circular record medium from a special form record medium disk.

Furthermore, the decision device instructs a transfer device to eject the special form record medium from the main casing when the decision device has decided that an inserted record medium is not circular. Thus, the special form record medium can be ejected before it is completely received into the main casing.

The decision device may have a first disk decision part, which includes a symmetry decision section for determining whether an inserted record medium has a symmetrical shape, a diameter decision section for determining an outer diameter of the inserted record mediums, and an outline decision section for determining an outline of the inserted record medium.

The decision device may have a second disk decision part for determining an outer diameter and an outline of an inserted record medium when the symmetry decision section has decided that the inserted record medium is unsymmetrical.

A record medium recognition method according to the present invention may have includes the steps of determining whether an inserted record medium has a symmetrical shape, determining an outer diameter of the inserted record medium, and determining an outline of the record medium.

The record medium recognition method may include a second disk decision step of determining an outer diameter and an outline of the inserted record medium when the symmetry decision step has decided that the inserted record medium is unsymmetrical.

### Embodiment

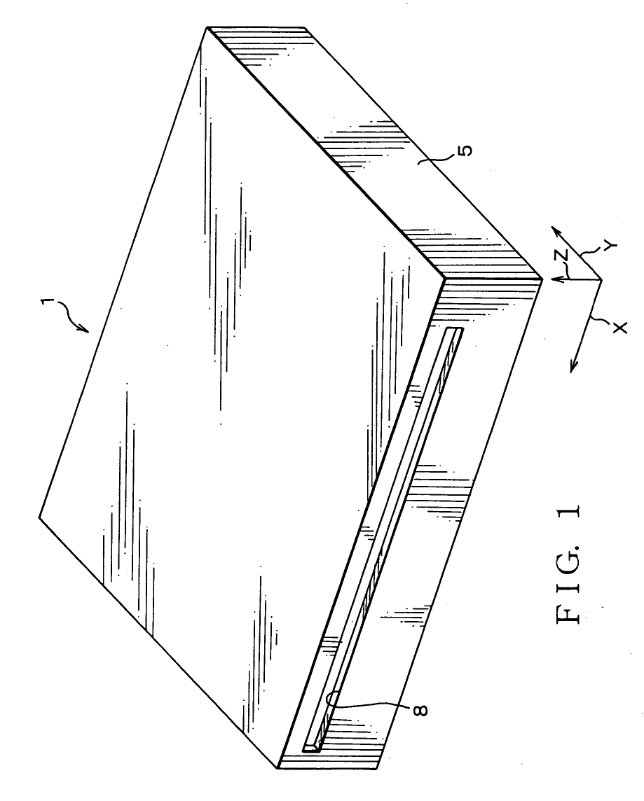

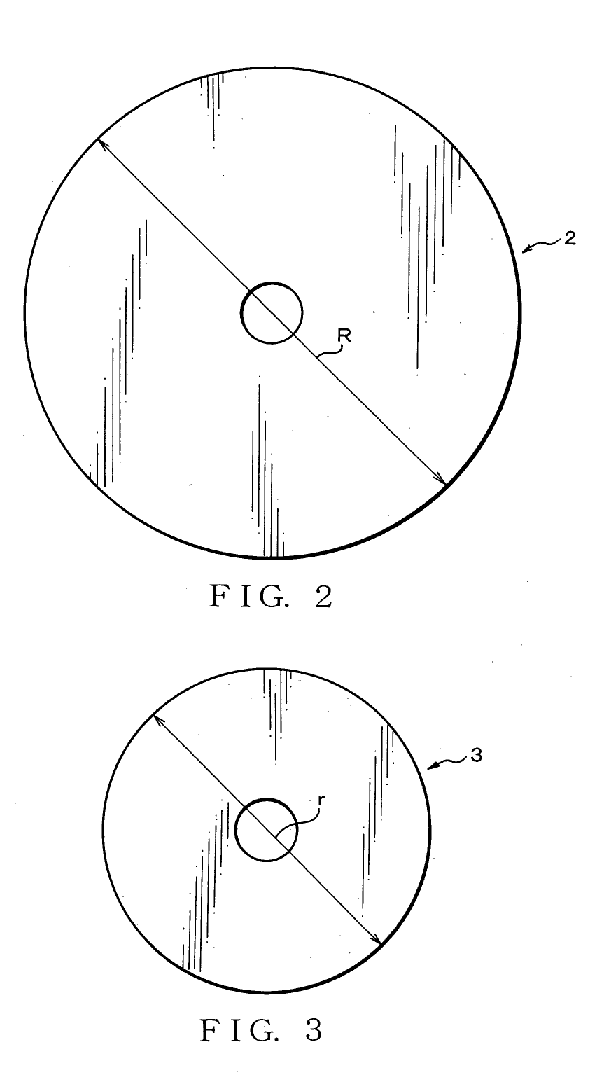

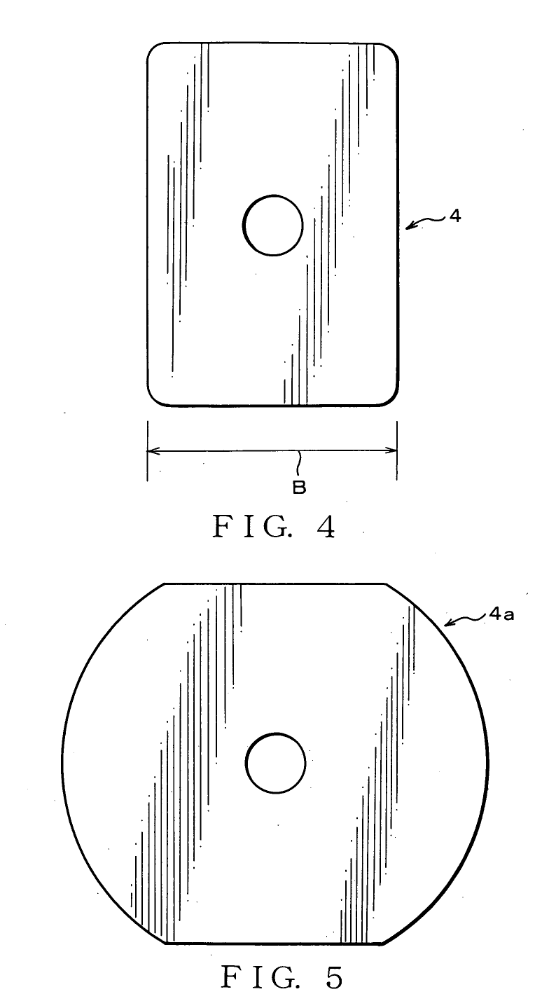

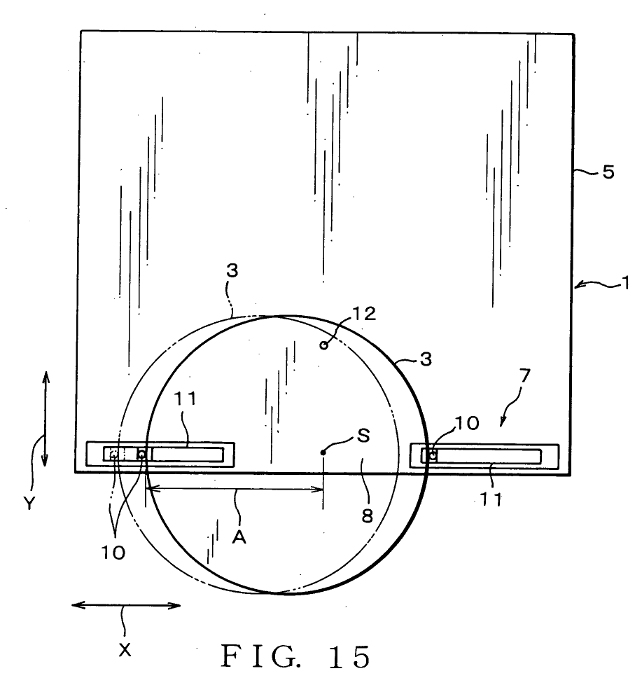

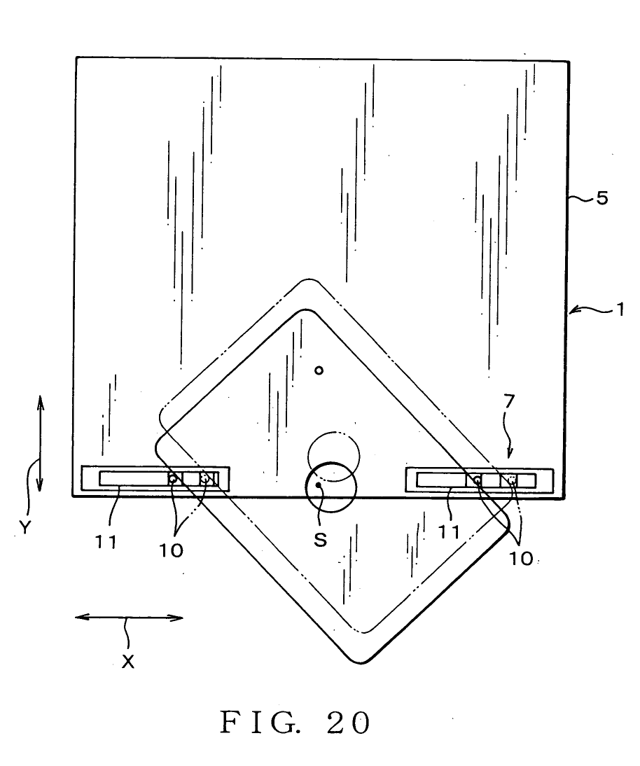

Referring to FIGS. 1 to 20, a CD player 1, which is a record medium reproduction unit of an embodiment according to the present invention will be discussed. The CD player 1 shown in FIG. 1 is disposed, for example, in an instrument panel of a motor vehicle. The CD player 1 receives selectively a larger CD 2 shown in FIG. 2 and a smaller CD 3 shown in FIG. 3 in a main casing 5 discussed later. The CD player 1 reproduces audio information stored in the CDs 2 and 3.

The CDs 2 and 3 are each a thin circular plate or disk that is a disk shaped record medium readable by an electronic instrument including a computer. In this embodiment, the larger CD 2 has an outer diameter R of 12 cm, and the smaller CD 3 has an outer diameter r of 8 cm.

The CD player 1 can prevent a card-shaped CD 4 shown in FIG. 4 from entering the main casing 5. The card-shaped CD 4 is rectangular in a plan view. The card-shaped CD 4 has a short side width B that is smaller than the outer diameter r of the smaller CD 3. The card-shaped CD 4 is a special form record medium described hereinafter, which has a plan outline different from that of a circular one.

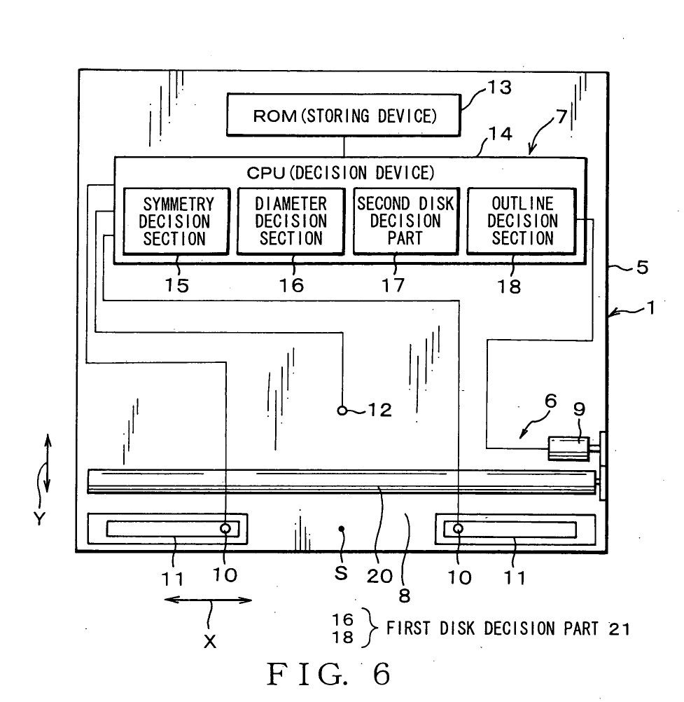

The CD player 1, as shown in FIG. 6, has the main casing 5 of FIG. 1, a transfer device 6, a reproduction device (not shown), and a decision device 7. In FIG. 1, an arrow X shows a width direction; an arrow Y shows a longitudinal direction; and an arrow Z shows a depth direction in respect of the CD player 1.

The main casing 5 is a box having a relatively small depth. The main casing S has an entry opening 8 respectively passing the CDs 2 and 3 into and out of the main casing 5 via the entry opening 8. The main casing 5 has a display panel (not shown) arranged with operation switches and a liquid crystal display for indicating operational states of the CD player 1.

The transfer device 6, as illustrated in FIG. 6, has a driving motor 9 and a roller 20. The motor 9 is accommodated and secured in the main casing 5.

The roller 20 is positioned near the entry opening 8 and rotatably supported in the main casing 5. The axial direction of the roller 20 is along the width direction X of the CD player 1 or a longitudinal direction of the entry opening 8. The roller 20 is rotated by the motor 9, and the roller 20 contacts any one of CDs 2, 3, and 4 so that the transfer device 6 can pass the CD through the entry opening 8 into and out of the main casing 5.

The reproduction device is accommodated in the main casing 5 to position an inserted CD 2 or 3 into main casing 5 to clamp it. Then, the CD 2 or 3 is rotated to output audio information stored in the CD.

The decision device 7, as shown in FIG. 6, has an insertion recognition sensor (not shown), a pair of sensing pins 10, a pair of travel sensors 11 of a sensing device, a disk sensor 12, a ROM 13 of a storing device, and a CPU 14 of a decision device.

The disk sensor has a laser diode (LD), a photodiode (PD), etc. and is arranged near the entry opening 8 in the main casing 5. The LD emits laser beams and the PD receives the laser beams emitted from the LD. The disk sensor detects insertion of an object into the main casing 5 when a laser beam emitted from the LD is obstructed by the object inserted into the entry opening 8. The disk sensor outputs a signal, which shows that an object has been inserted into the main casing 5, to the CPU.

The sensing pins 10 are disposed near the entry opening 8 in the main casing 5. The sensing pins 10 are opposed to each other with a space therebetween along the width direction X of the main casing 5. The sensing pins 10 stand on a bottom or top wall of the main casing 5. The sensing pins 10 are movable along the width direction X of the main casing 5 and are resiliently biased to come toward each other by coil springs (not shown). That is, the pair of sensing pins 10 are movable toward and away from each other.

The sensing pins 10 are positioned such that an outer edge of the larger CD 2 contacts the pins when the larger CD 2 is inserted as shown in FIGS. 9 to 11. The inserted larger CD 2 pushes the sensing pins 10 to move them apart from each other against the resiliently biasing spring coils. Then, the sensing pins 10 move toward each other after the middle of the larger CD 2 has passed between the sensing pins 10.

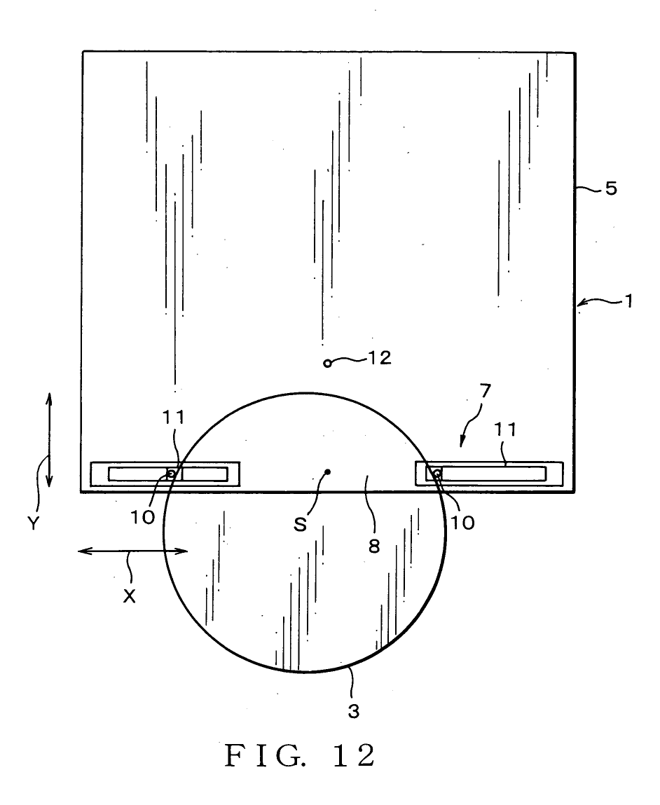

The sensing pins 10 are positioned such that an outer edge of the smaller CD 3 contacts at least one of the pins when the smaller CD 3 is inserted as shown in FIGS. 12 to 14. The inserted smaller CD 3 pushes the one of sensing pins 10 to move it apart from the other against the resiliently biasing spring coil. Then, the one sensing pin 10 moves toward the other after the middle of the smaller CD 3 passes between the sensing pins 10.

The pair of travel sensors 11 each are mounted with one of the sensing pins 10. Each travel sensor 11 detects a travel distance of each sensing pin 10 along the width direction of the main casing 5. In the illustrated embodiment, each travel sensor 11 outputs a signal, which shows a distance between the travel sensor 11 and the center S of the travel sensors 11, toward CPU 14.

The travel sensor 11 may be a variable resister, a magnetic reluctance element, a magnet scale, a photoelectric travel sensor, or the like. The travel sensor 11 may be constituted by a plurality of switches arranged along a travel direction the sensing pin 10, which turn on and off according to the position of the sensing pin 10 to know the position of the sensing pin 10.

The disk sensor 12 has a conventional laser diode (LD) emitting laser beams and a conventional photodiode (PD) receiving laser beams, and the disk sensor 12 is disposed near the entry opening 8 in the main casing 5. The disk sensor 12 is positioned at a central point away from the center S of the pins in the longitudinal direction Y of the main casing 5.

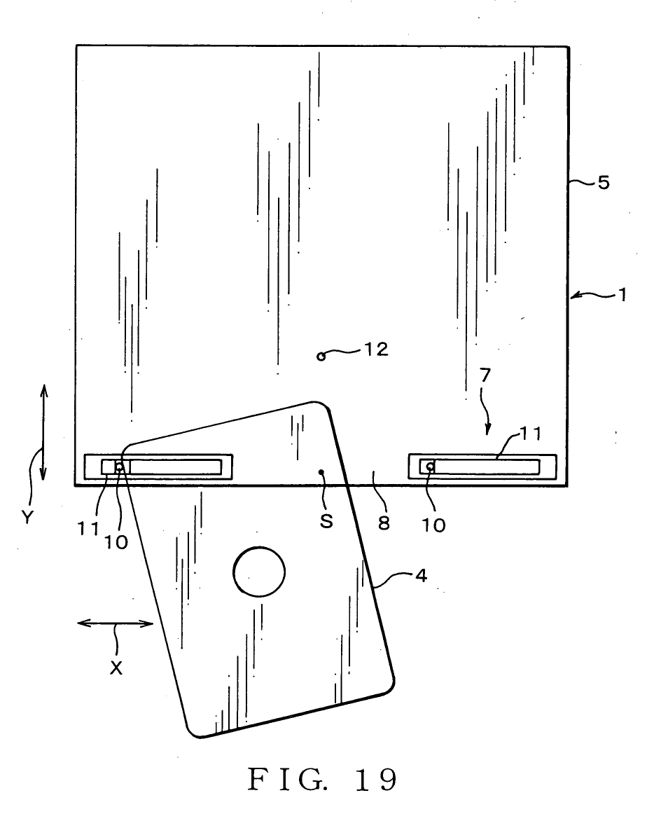

The disk sensor 12 is positioned such that a laser beam emitted from the LD is prevented from reaching the PD when a circular CD 2 or 3 covers the PD while the sensing pins 10 are moving toward each other. Meanwhile, as shown in FIG. 19, when a card-shaped CD 4 of a special form record medium is inserted into the main casing 5, the card-shaped CD 4 may contact only one of the sensing pins 10. In this state, the card-shaped CD 4 does not obstruct a laser beam emitted from the LD toward the PD yet. However, the card-shaped CD 4 obstructs the beam emitted from the LD toward the PD after the card-shaped CD 4 has contacted the pair of sensing pins 10.

The disk sensor 12 obstructs the beam emitted from the LD toward the PD, so that the insertion of the CD 2 or 3 into the main casing 5 via the opening 8 is recognized. The disk sensor 12 outputs a signal to CPU 14 for showing that the CD 2 or 3 has been inserted into the main casing 5.

ROM 13 stores a program for operating the CD player 1. ROM 13 also stores a second program for operating CPU 14 as discussed later.

As shown in FIG. 6, CPU 14 has a symmetry decision section 15, a first disk decision part 21, and a second disk decision part 17. CPU 14 operates along the second program stored in ROM 13. When CPU 14 receives a signal showing that an object has been inserted into the entry opening 8, CPU 14 controls the motor 9 to rotate the roller 20 to move forward the object into the main casing 5. CPU 14 determines whether at least one of sensing pins 10 is moving based on information supplied from the travel sensors 11. CPU 14 controls the motor 9 to rotate oppositely when CPU 14 has determined that both the sensing pins 10 are standstill based on information supplied from the travel sensors 11.

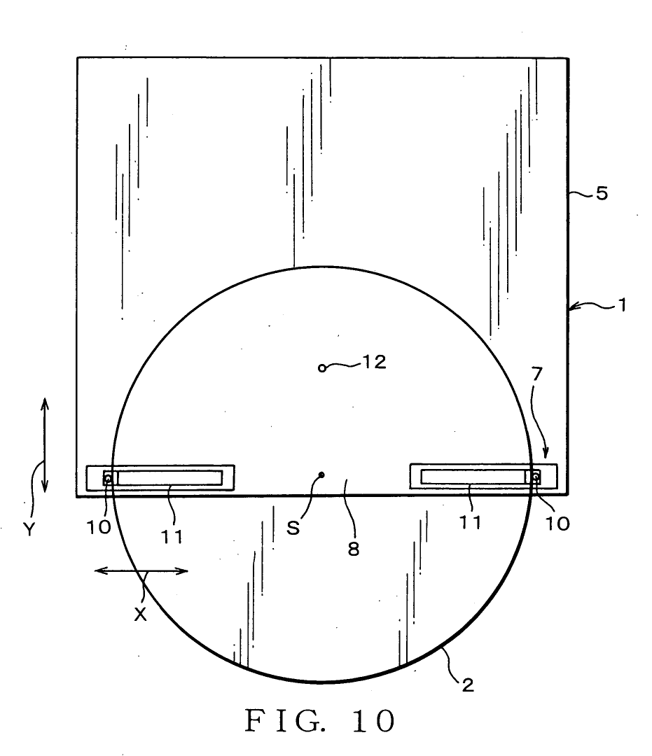

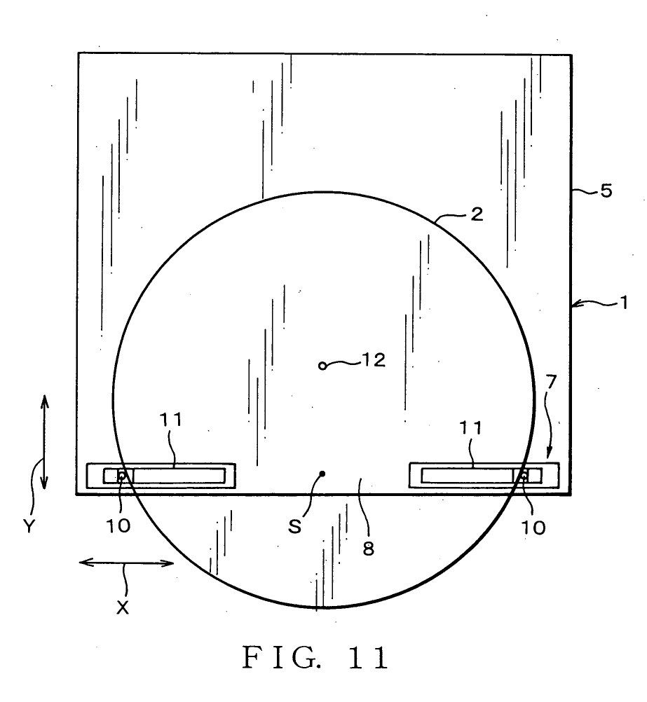

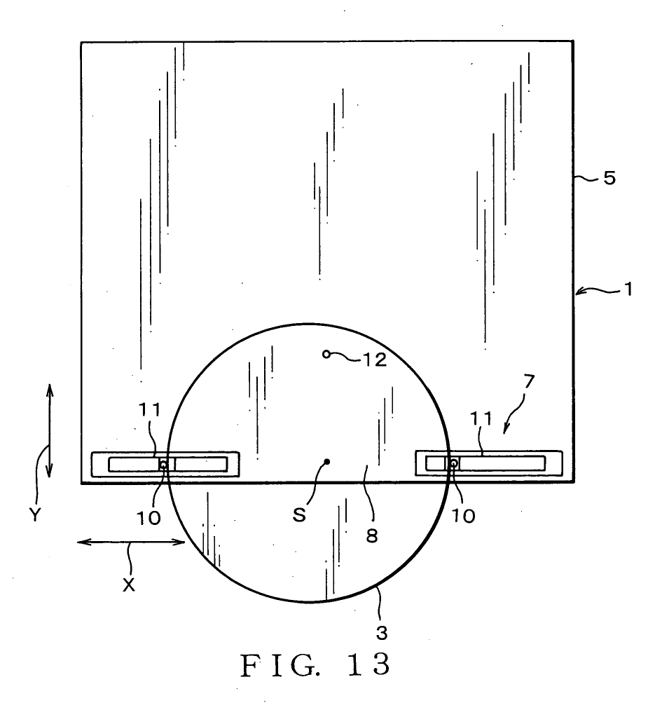

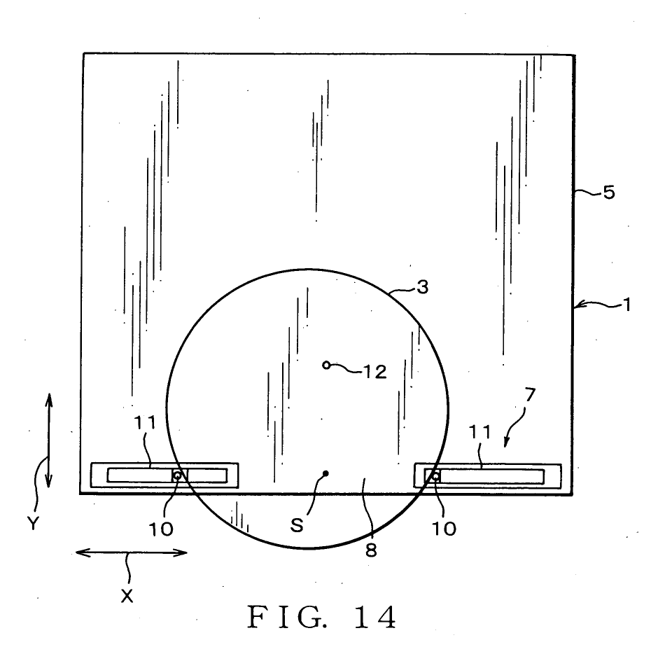

The symmetry decision section 15 determines whether the sensing pins 10 are moving substantially synchronously toward each other based on information supplied from the travel sensors 11 of the sensing pins 10 after the sensing pins 10 has begun to move away from each other. As shown in FIGS. 10 and 13, both the sensing pins 10 move synchronously toward each other while the sensing pins 10 are contacting the CD 2 or 3.

Thus, the symmetry decision section 15 determines whether the pair of sensing pins 10 are moving synchronously toward each other to know which has been inserted into the entry opening 8, a circular CD or a card-shaped CD 4 of a special form record medium. The symmetry decision section 15 determines that a circular CD 2 or 3 has been inserted into the main casing 5 when the sensing pins 10 moves synchronously toward each other. The symmetry decision section 15 determines that a special form record medium such as a card-shaped CD 4 has been inserted into the main casing 5 when the sensing pins 10 does not move synchronously (with different speeds) toward each other. That is, the symmetry decision section 15 determines whether the inserted record medium has a symmetrical outline or not.

The first disk decision part 21 has a diameter decision section 16 and an outline decision section 18. The diameter decision section 16 calculates a distance (particularly a maximum thereof) between the pair of sensing pins 10 based on information supplied from the travel sensors 11, after the symmetry decision section 15 has determined that the inserted CD has a symmetrical shape. The diameter decision section 16 determines whether the maximum distance is equal to an outer diameter R or r of the CD 2 or 3. When the diameter decision section 16 determines that the maximum distance of the inserted CD is different from each of the outer diameters R and r, CPU 14 controls the motor 9 to rotate it oppositely.

The outline decision section 18 calculates a travel rate (traveling speed of the pins moving toward each other) of the sensing pins 10, after the diameter decision section 16 has determined that a CD having a diameter equal to CD 2 or 3 is inserted. The outline decision section 18 determines whether the calculated travel rate is within a predetermined range. The predetermined range includes a travel rate of the sensing pins 10 when each CD 2 or 3 is inserted between the sensing pins 10.

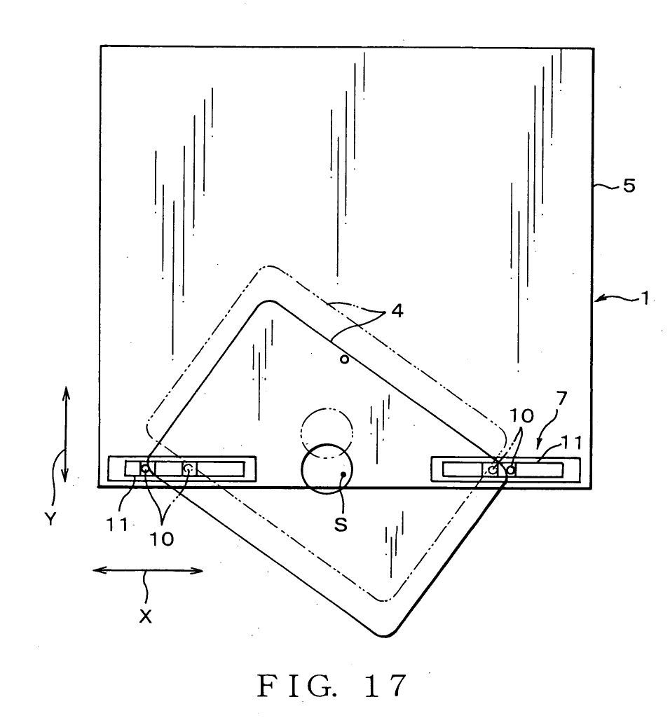

As shown in FIGS. 9 to 14, a travel rate of the sensing pins 10 is much smaller when the CD 2 or 3 is passing between the sensing pins 10 as compared with that of the card-shaped CD 4. As shown in FIG. 17, a travel rate of the card-shaped CD 4 is larger when the card-shaped CD 4 moves from a state illustrated with a solid line to another state illustrated with a chain line. Thus, the outline decision section 18 can determine that a larger CD 2 or a smaller CD 3 has been inserted into the main casing 5. The outline decision section 18 can also determine that a symmetrical barrel-shaped CD 4a shown in FIG. 5 has been inserted. The outline decision section 18 can determine whether a CD inserted into the main casing 5 is circular, after the symmetry decision section 15 has determined that the CD is symmetrical and the diameter decision section 16 has determined that the CD has a diameter equal to that of the CD 2 or 3. That is, the outline decision section 18 determines a shape of an inserted CD based on a travel rate of the sensing pins 10 contacting the CD.

A second disk decision part 17 determines that a smaller CD 3 or a special form record medium such as a CD4 has been inserted into the main casing 5 when the symmetry decision section 15 has determined that an inserted object is unsymmetrical. Because, the smaller CD 3 may contact only one of the sensing pins 10, and the card-shaped CD 4 may not be symmetrically inserted into the main casing 5 even when the CD 4 is contacting each of the sensing pins 10.

Even when the symmetry decision section 15 determines that a CD inserted into the main casing 5 is unsymmetrical, at least one of the sensing pins 10 has been moved with its abutment against the inserted CD. When the symmetry decision section 15 has determined that the inserted CD is unsymmetrical, the second disk decision part 17 determines whether one of the sensing pins 10 is moving when the other pin begins to move toward the one of pins.

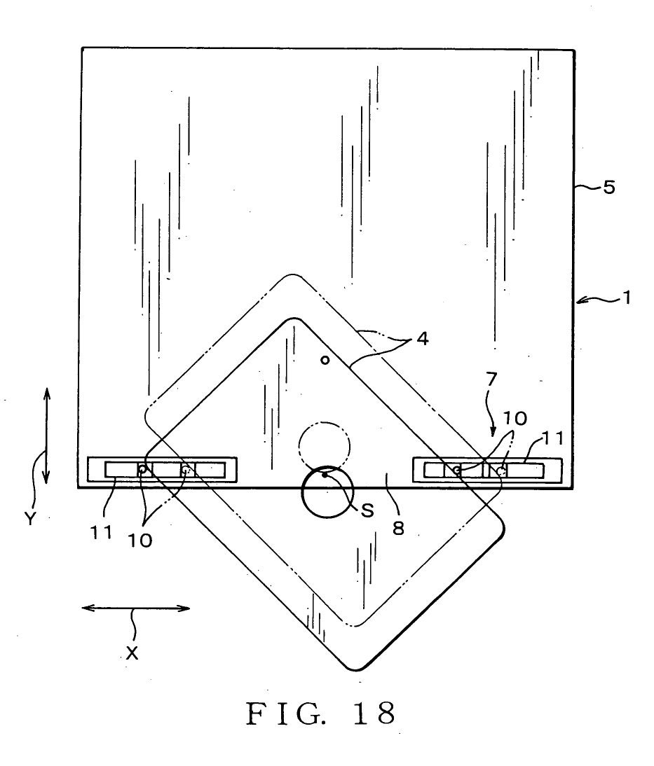

As shown in FIG. 18, the card-shaped CD 4 may contact the pair of sensing pins 10. Even when the card-shaped CD 4 moves from a state shown with a solid line to another state shown with a chain line, one of the sensing pins 10 may move toward the other while the other pin 10 moves away from the one of sensing pins 10. This can distinguish the card-shaped CD 4 from the smaller CD 3 that is contacting only one of the sensing pins 10.

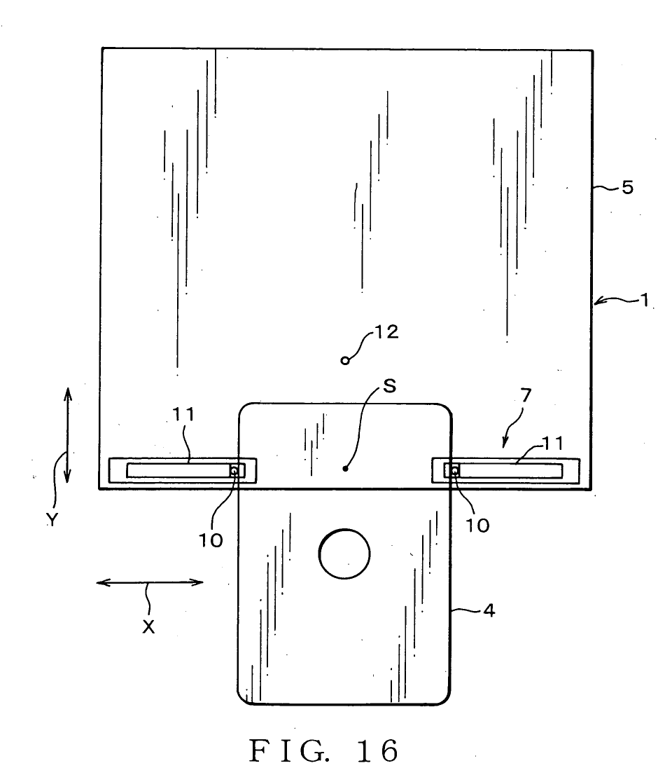

The second disk decision part 17 determines whether one of the sensing pins 10 is apart more than a given distance A from the center S based on information supplied from the travel sensors 11, when the sensing pins 10 begin to move toward each other as shown in FIG. 15. The given distance A is a minimum when only the one of the sensing pins 10 contacts the smaller CD 3 and begins to move toward the other.

Furthermore, the second disk decision part 17 determines whether a laser beam emitted from the LD to the PD of the disk sensor is obstructed or not when the one of sensing pins 10 begins to move toward the other. When the beam is obstructed, the second disk decision part 17 determines that the smaller CD 3 has been inserted into the main casing 5. Meanwhile, when the beam is not obstructed, the second disk decision part 17 determines that a special form record medium like a card-shaped CD 4 has been inserted into the main casing 5. Thereby, the second disk decision part 17 determines whether the inserted record medium is the smaller CD 3 or the card-shaped CD 4.when the record medium is contacting only one of the sensing pins 10.

Moreover, the second disk decision part 17 determines whether the other pin 10 remains standstill, when a laser beam emitted from the LD of the disk sensor 12 has been obstructed and the one of sensing pins 10 begins to move toward the other pin. If the other pin is moving, it shows that a special form record medium like the card-shaped CD 4 is pushing the other pin. Thereby, the second disk decision part 17 determines whether the inserted record medium is the smaller CD 3 or the card-shaped CD 4 based on the movement of the other pin when the one of sensing pins 10 begins to move toward the other pin. When the one of sensing pins 10 remains standstill, the second disk decision part 17 determines an outer diameter r and an outline of the smaller CD 3 based on the position of the other pin 10.

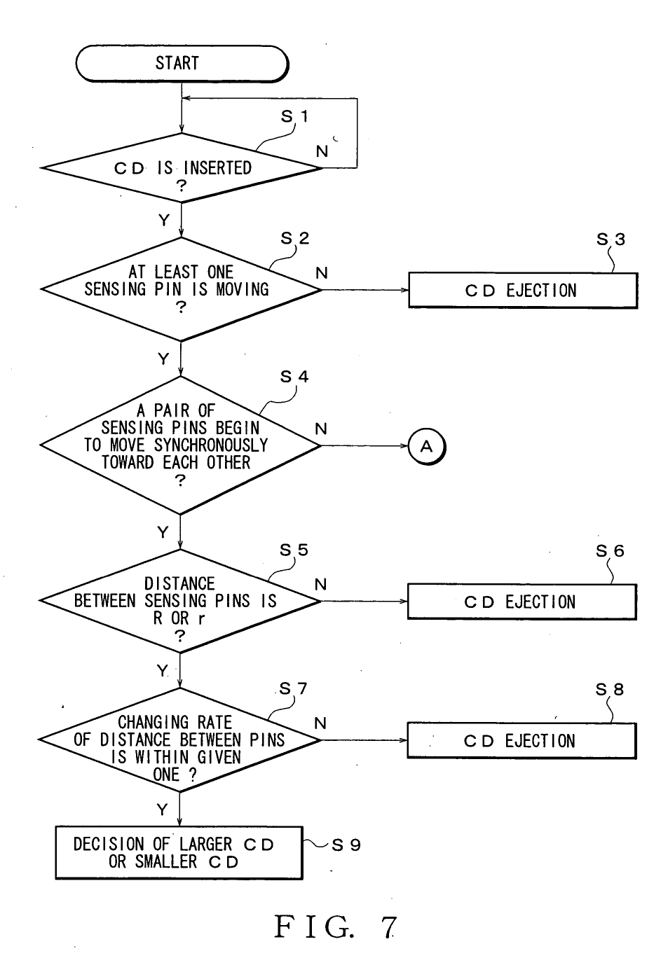

The roller 20 of the CD player 1 remains standstill when none of the CDs 2, 3, and 4 are inserted or ejected into or from the main casing 5. When the CD 2, 3, or 4 is inserted into the main casing 5 of the CD player 1, CPU 14 determines whether an object like the CD 2, 3, or 4 is inserted into the entry opening 8 based on information provided from the disk sensor at step S1 of FIG. 7. When the decision is negative, CPU 14 repeats step S1. When the decision is affirmative, CPU 14 controls the motor 9 to operate such that the roller 20 rotates to forward the inserted CD into the main casing 5. Then, the execution goes to step S2. Thus, at step S1, the roller 20 begins to rotate when the CD, 2, 3, or 4 is inserted into the entry opening 8. Meanwhile, the roller 20 remains standstill when none of the CDs, 2, 3, and 4 are inserted into the entry opening 8.

At step S2, CPU 14 determines whether at least one of the sensing pins 10 is pushed and moved by the inserted CD 2, 3, or 4. When none of the sensing pins 10 are moved, step S2 can recognize that the CD 4 is inserted just straight into the main casing 5 as shown in FIG. 16 or that the inserted object has been drawn out. At step S2, when the decision is affirmative, the execution goes to step S4, and when the decision is negative, the execution goes to step S3.

At step S4, the diameter decision section 16 of CPU 14 determines whether the pair of sensing pins 10 begin to move synchronously based on travel information of the sensing pins 10 from the travel sensors 11. Thereby, the diameter decision section 16 can determine whether the inserted CD 2, 3, or 4 has a symmetrical outline like a circle.

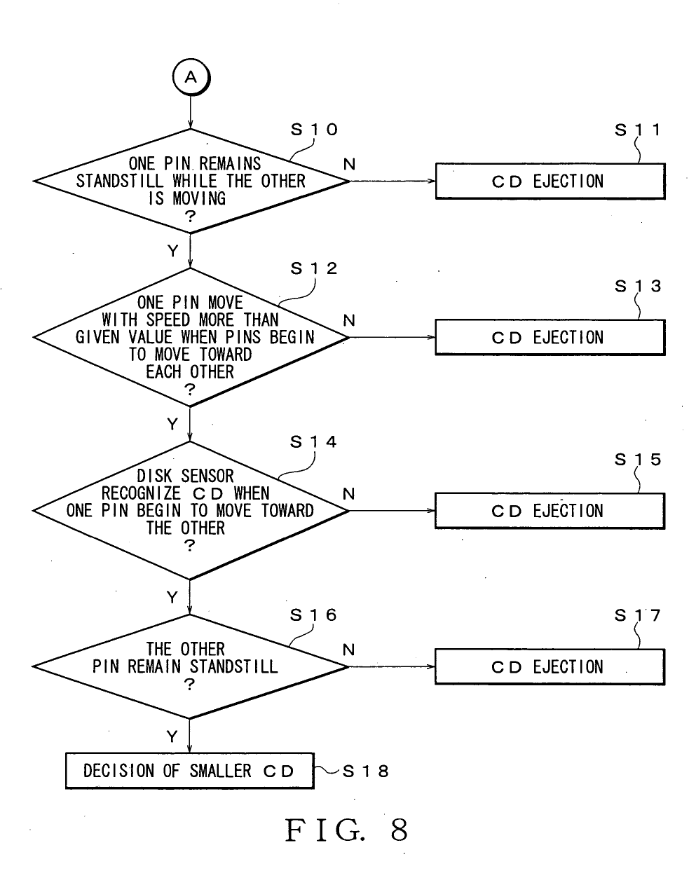

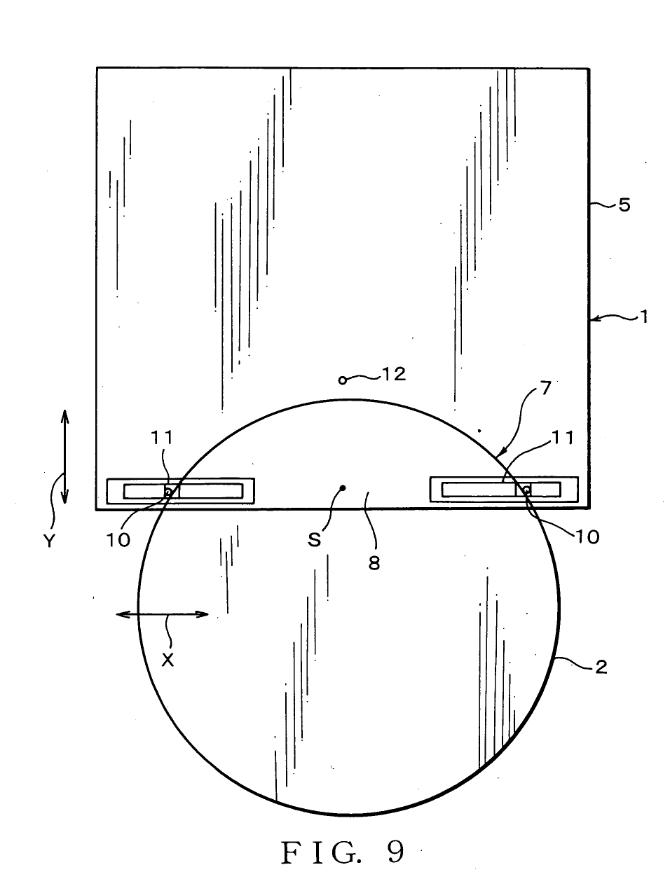

When CPU 14 determine that a symmetrical object like the CD 2 is inserted in the entry opening 8 at step S4, the execution goes to step S5. Meanwhile, step S4 determines that the pair of sensing pins 10 do not begin to move synchronously to each other, the execution goes to step S10 of FIG. 8. Note that step S4 corresponds to the aforementioned symmetry decision step for determining that the inserted CD is symmetrical or not when the sensing pins 10 begin to move toward each other.

At step S5, based on information supplied from the travel sensors 11 in respect of travels of the sensing pins 10, the diameter decision section 16 of CPU 14 calculates a distance (maximum one) between the sensing pins 10 when the sensing pins 10 begin to move synchronously toward each other. The diameter decision section 16 also determines whether the calculated distance between the sensing pins 10 is equal to one of the diameters R and r or not.

When the diameter decision section 16 of CPU 14 determines that the calculated distance between the sensing pins 10 is equal to one of the diameters R and r, the execution goes to step S7. Meanwhile, When the diameter decision section 16 determines that the calculated distance between the sensing pins 10 is not equal to any one of the diameters R and r, the execution goes to step S6. Note that step S5 corresponds to the aforementioned diameter decision device for determining an outer diameter of a CD inserted into the main casing 5 based on the maximum distance between the pair of sensing pins 10.

At step S7, based on information supplied from the travel sensors 11 in respect of travels of the sensing pins 10, the outline decision section 18 of CPU 14 calculates a travel rate of the distance between the sensing pins 10 when the sensing pins 10 move toward each other. The outline decision section 18 determines whether the calculated travel rate is within a predetermined range. When the decision is affirmative, the execution goes to step S9. Meanwhile, when the decision is negative, the execution goes to step S8. Note that step S7 corresponds to the aforementioned outline decision device for determining which one of the CD 2, 3, or 4 is inserted and for determining the shape of the inserted CD based on the travel rates of the sensing pins 10.

At step S9, CPU 14 determines which has been inserted into the main casing 5, the larger CD 2 or the smaller CD 3.

At steps S3, S6, and S8, CPU 14 determines that a special form record medium like the card-shaped CD 4 has been inserted into the main casing 5, and the motor 9 rotates oppositely to move the roller 20 to eject the special form record medium from the main casing 5.

Thus, Steps S1 to S9 determine that the larger CD 2 has been inserted into the main casing 5, that the smaller CD 3 has contacted both the sensing pins 10, and that the card-shaped CD 4 has been inserted into the main casing 5.

Referring to FIG. 8, at step S10, the second disk decision part 17 of CPU 14 determines whether one of the sensing pins 10 remains standstill when the other pin moves toward the one of sensing pins 10. The decision is affirmative, the execution goes to step S12. Meanwhile, the decision is negative, the execution goes to step 11.

When the one of sensing pins 10 remains standstill at step S10, only the one of sensing pins 10 is contacting the smaller CD 3 or the card-shaped CD 4. When the one of sensing pins 10 is also moving at step S10, it is supposed that the card-shaped CD 4 is contacting each of the sensing pins 10. However, the one of the pins 10 is moving to come away from the other pin, while the other pin is moving toward the one of the sensing pins 10.

At step S12, the second disk decision part 17 of CPU 14 determines whether one of the sensing pins 10 is apart from the center S more than the given distance A based on information supplied from the travel sensors 11, when the sensing pins 10 begin to move toward each other. The given distance A is a minimum when only the one of the sensing pins 10 contacts the smaller CD 3 and begins to move toward the other. The decision is affirmative, the execution goes to step S14. Meanwhile, the decision is negative, the execution goes to step 13. When the distance between the sensing pins 10 is more than the given one A, it is supposed that the smaller CD 3 or the card-shaped CD 4 has contacted only one of the sensing pins 10.

At step S14, the second disk decision part 17 of CPU 14 determines whether a laser beam emitted from the LD to the PD of the disk sensor 12 is obstructed or not based on information supplied from the disk sensor 12 when the one of sensing pins 10 begins to move toward the other. That is, step S14 determines whether the disk sensor 12 has detected the smaller CD 3.

When the beam of the disk sensor 12 is obstructed, the execution goes to step S16. Meanwhile, when the beam is not obstructed, the execution goes to step S15.

More specifically, at step 14, when the beam is obstructed, the second disk decision part 17 determines that the smaller CD 3 has been inserted into the main casing 5. Meanwhile, when the beam is not obstructed, the second disk decision part 17 determines that a special form record medium like the card-shaped CD 4 has been inserted into the main casing 5. Thereby, the second disk decision part 17 determines whether an inserted record medium is the smaller CD 3 or the card-shaped CD 4 when the record medium is contacting only one of the sensing pins 10.

At step S16, the second disk decision part 17 of CPU 14 determines whether one of the sensing pins 10 remains standstill based on information supplied from the travel sensors 11 when the other pin moves toward the one of sensing pins 10. The decision is affirmative, the execution goes to step S18. Meanwhile, the decision is negative, the execution goes to step S17.

When the one of sensing pins 10 remains standstill at step S16, the other of sensing pins 10 is contacting the smaller CD 3. When the one of sensing pins 10 is also moving at step S16, it is supposed that the card-shaped CD 4 is contacting each of the sensing pins 10.

At step S18, the second disk decision part 17 of CPU 14 determines that the smaller CD 3 has been inserted into the main casing 5. At steps S11, S13, S15, and S17, CPU 14 determines that a special form record medium like the card-shaped CD 4 has been inserted into the main casing 5, and the motor 9 rotates oppositely to drive the roller 20 to eject the special form record medium from the main casing 5. Thus, steps S10 to S18 determine that the smaller CD 3 has contacted only one of the sensing pins 10 or that the card-shaped CD 4 has been inserted into the main casing 5. Steps S10 to S18 corresponds to the second disk decision part described already. When step S4 determines that an inserted CD is unsymmetrical and the pair of sensing pins 10 are moving at the same time, steps S10 to S18 determine that the inserted CD is a special form record medium like the card-shaped CD 4. During steps S10 to S18, one of the sensing pins 10 remain standstill while the inserted CD is determined in an outer diameter or outline thereof.

Accordingly, CPU 14 determines which has been inserted into the main casing main casing 5, the larger CD 2, the smaller CD 3, or a special form CD like a card-shape one based on information supplied from the travel sensors 11 in respect of travels of the sensing pins 10. Furthermore, when CPU 14 determines that a special form record medium like the card-shaped CD 4 has been inserted into the main casing 5 at step S3, S6, S8, S11, S13, S15, or S17, the special form record medium is ejected from the main casing 5.

According to the embodiment, CPU 14 determines which has been inserted into the main casing 5, the larger CD 2, the smaller CD 3, or a special form CD 4 like the card-shaped one based on travel distances of the pair of sensing pins 10 contacting the CD. Thus, a record medium inserted into the main casing 5 is surely recognized.

When CPU 14 determines that an inserted CD is the card-shaped CD 4 having a special form, the transfer device 6 ejects the card-shaped CD 4. Thus, before a special form record medium like the card-shaped CD 4 is completely received in the main casing 5, the special form record medium is ejected from the main casing 5, eliminating that the special form record medium can not be ejected from the main casing 5.

At step S4, the symmetry decision section 15 determines whether an inserted CD has a symmetrical shape or not. Thus, the inserted CD is determined to be one of the circular CDs 2 and 3 or the card shaped CD 4.

At step S5, the diameter decision section 16 determines an outer diameter R or r of the CD 2 or 3 that has been decided to be a symmetrical one. Thus, the inserted CD is determined to be the larger CD 2 or the smaller CD 3.

During steps S10 to S18, the second disk decision part 17 can determine whether an inserted CD is the smaller CD 3 or the card-shaped CD.

At step S7, the outline decision section 18 determines whether an inserted CD has a circular shape or not. Thus, the inserted CD is determined to be one of the CDs 2, 3 of disk-shaped record mediums or the card-shaped CD 4.

In the embodiment, the card-shaped rectangular CD 4 shown in FIG. 4 is discussed as a special form record medium. However, in the present invention, the card-shaped CD 4a having a barrel shape shown in FIG. 5 in a plan view may be applied as a special form record medium. The special form record medium described in relation to the present invention has a shape other than a circle. Various types of sensors may be utilized as a sensing device for the sensing pin 10.

Furthermore, without the disk sensor having the LD and PD, step S1 may determine whether an object like the CD 2, 3, or 4 has been inserted based on information supplied from the travel sensors 11 that recognize the movements of the sensing pins 10. In this case, at least one of the sensing pins 10 moves when an object like the CD 2, 3, or 4 is inserted into the entry opening 8.

In summary, the CD player 1 is configured as follows:

(1) The CD player 1 has a main casing 5 for respectively receiving a larger CD 2 and a smaller CD 3 to reproduce information recorded in the record mediums 2, 3. The CD player 1 includes:
a pair of sensing pins 10 movable toward and away from each other and resiliently biased toward each other, the sensing pins 10 each contacting an outer edge of the larger CD 2 to move away from each other when the larger CD 2 enters the main casing 5, at least one of the sensing pins 10 contacting an outer edge of the smaller CD 3 such that the sensing pins 10 move away from each other when the smaller CD 3 enters the main casing 5,
a travel sensor 11 for detecting a travel distance of each of the sensing pins 10,
a transfer device 6 transferring any one of CDs 2, 3, 4, and 4a into and out of the main casing 5, and
a CPU 14 for determining which is inserted into the main casing 5, the larger CD 2, the smaller CD 3, or a card-shaped record medium 4 or 4a different from the larger and smaller CDs 2, 3 in outline based on travel distances of the pair of sensing pins 10, thereby preventing the card-shaped record medium 4 or 4a from entering the main casing 5 and to eject the card-shaped record medium 4 or 4a from the main casing 5 by the transfer device 6.

(2) Furthermore, CPU 14 includes a diameter decision section 16 for determining an outer diameter of the inserted record medium and an outline decision section 18 for determining an outline of the inserted record medium based on travel rates of the sensing pins 10 when the sensing pins 10 moves toward each other.

(3) Moreover, CPU 14 has a symmetry decision section 15 for determining whether the inserted CD 2, 3, 4, or 4a has a symmetrical outline. The symmetry decision section 15 determines whether the inserted record medium has a symmetrical shape when the sensing pins 10 each contact an outer edge of the inserted CD and move toward each other. The diameter decision section 16 determines an outer diameter and the outline decision section 18 determines an outline of the inserted CD when the CD is determined to be a symmetrical shape. CPU 14 also has a disk decision part 17 for determining that the inserted CD is the special form record medium when the inserted CD is unsymmetrical based on movements of the pair of sensing pins 10. A second disk decision part 17 also determines an outer diameter of the inserted CD 2, 3, 4, or 4a based on a movement of one of the sensing pins 10 when the other of the sensing pins 10 remains standstill.

(4) A method of determining a record medium is provided for a CD player 1. The CD player 1 has a main casing 5 for respectively receiving a larger CD 2 and a smaller CD 3 to reproduce information recorded in the CDs 2 and 3. The reproduction unit has a pair of sensing pins 10 movable toward and away from each other and resiliently biased toward each other. The sensing pins 10 each contact an outer edge of the larger CD 2 to move away from each other when the larger CD 2 enters the main casing 5. At least one of the sensing pins 10 contacts an outer edge of the smaller CD 3 such that the sensing pins 10 move away from each other when the smaller CD 3 enters the main casing 5. The reproduction unit further has a sensing device for detecting travel distances of the sensing pins 10. The method includes:
the step 5 for determining an outer diameter of any one of the CDs 2 and 3 based on a maximum distance between the pair of sensing pins 10, and
the step 7 for determining a shape of any one of the CDs 2, 3, 4, and 4a based on a travel rate of each of the sensing pins 10 when the CD is contacting the outer edge of each of the sensing pins 10.

(5) The method further includes:
the step S4 for determining whether any one of the CDs has a symmetrical shape when the sensing pins 10 move toward each other during insertion of the CD into the main casing 5, the steps 5 and 7 determining an outer diameter and an outline of the CD when the CD is determined to be a symmetrical shape, and
the steps S10 to S18 for determining that the inserted CD is a special form record medium 4 or 4a different from the larger CD 2 and smaller CD 3, for determining that the CD is unsymmetrical based on movements of the pair of sensing pins 10 during insertion of the CD; and for determining an outer diameter of a record medium based on a movement of one of the sensing pins 10 when the other of the sensing pins 10 keeps standstill during insertion of the CD into main casing 5.

Note that the descriptions of the embodiments intent to discuss the present invention and do not limit the present invention. Various modified embodiments will be provided within the scope of the present invention.

Incidentally, the contents of Japanese Application No. 2004-104743, of which the applicant of this application claims the benefit, is hereby incorporated for reference.

1. A record medium reproduction unit having a main casing for respectively receiving a larger disk record medium and a smaller disk record medium to reproduce information recorded in the record mediums, the reproduction unit comprising:
a pair of sensing pins movable toward and away from each other and resiliently biased toward each other, the sensing pins each contacting an outer edge of the larger disk record medium to be moved away from each other when the larger disk record medium enters the main casing, at least one of the sensing pins contacting an outer edge of the smaller disk record medium to be moved away from the other pin when the smaller disk record medium enters the main casing,
a sensing device for detecting a travel distance of each of the sensing pins,
a transfer device for transferring the record mediums into and out of the main casing, and
a decision device for determining which is being inserted into the main casing, the larger disk record medium, the smaller disk record medium, or a special form record medium based on a travel distance of each of the sensing pins, the transfer device ejecting the special form record medium from the main casing when the decision device determines that the special form record medium is inserted, the special form record medium being different from the larger and smaller disk record mediums in outline.

2. The reproduction unit recited in claim 1, wherein the decision device includes a first disk decision part having a diameter decision section and an outline decision section, the diameter decision section determining an outer diameter of a record medium inserted into the main casing, the outline decision section determining an outline of the inserted record medium.

3. The reproduction unit recited in claim 2, wherein the diameter decision section determines an outer diameter of the inserted record medium based on a maximum distance between the pair of sensing pins, and the outline decision section determines an outline of the inserted record medium based on a travel rate of each of the sensing pins when the sensing pins each contact an outer edge of the inserted record medium and move toward each other.

4. The reproduction unit recited in claim 2, wherein the decision device has a symmetry decision section for determining whether the inserted record medium has a symmetrical outline.

5. The reproduction unit recited in claim 4, wherein the symmetry decision section determines whether the inserted record medium has a symmetrical outline when the sensing pins each contact an outer edge of the inserted record medium and move toward each other.

6. The reproduction unit recited in claim 4, wherein the first disk decision part determines an outer diameter and an outline of the inserted record medium after the decision that the inserted record medium has a symmetrical shape, and the decision device has a second disk decision part for determining that the inserted record medium is the special form record medium when the inserted record medium is unsymmetrical based on movements of the pair of sensing pins, the second disk decision part determining an outer diameter of the inserted record medium based on a movement of one of the sensing pins when the other of the sensing pins remains standstill during insertion of the record medium into main casing.

7. A method for recognizing a record medium of a record medium reproduction unit having a main casing for respectively receiving a larger disk record medium and a smaller disk record medium to reproduce information recorded in the record mediums, the reproduction unit having a pair of sensing pins movable toward and away from each other and resiliently biased toward each other, the sensing pins each contacting an outer edge of the larger disk record medium to be moved away from each other when the larger disk record medium enters the main casing, at least one of the sensing pins contacting an outer edge of the smaller disk record medium to be moved from the other pin when the smaller disk record medium enters the main casing, the reproduction unit further having a sensing device for detecting a travel distance of each of the sensing pins, the method comprising the steps of:
determining an outer diameter of a record medium inserted into the main casing based on a maximum distance between the pair of sensing pins, and
determining an outline of the inserted record medium based on a travel rate of each of the sensing pins when the sensing pins each contact an outer edge of the inserted record medium and move toward each other.

8. The method recited in claim 7 further comprising the steps of:
determining whether the inserted record medium has a symmetrical shape when the sensing pins move toward each other during insertion of the record medium into the main casing,
determining an outer diameter and an outline of the inserted record medium after the record medium is determined to be a symmetrical shape,
determining that the inserted record medium is a special form record medium based on movements of the pair of sensing pins when the inserted record medium is unsymmetrical, and
determining an outer diameter and an outline of the record medium based on a movement of one of the sensing pins when the other of the sensing pins remains standstill during insertion of the record medium into main casing.
